(19) United States
(12) Patent Application Publication
(10) Pub. No.: US 2023/0351422 A1
(43) Pub. Date: Nov. 2, 2023

(54) METHOD AND SYSTEM OF TOURING REAL ESTATE AND SURVEYS FOR THE SAME

(71) Applicant: Michael Watts, Chicago, IL (US)

(72) Inventor: Michael Watts, Chicago, IL (US)

(21) Appl. No.: 17/793,279

(22) PCT Filed: Jan. 22, 2021
(86) PCT No.: PCT/US2021/014679

§ 371 Date: Jul. 15, 2022

Related U.S. Application Data
(60) Provisional application No. 62/964,224, filed on Jan. 22, 2020.

(51) Int. Cl. G06Q 30/0203; G06Q 50/16

(52) U.S. Cl. CPC G06Q 30/0203; G06Q 50/16

(57) ABSTRACT

Provided herein are systems and methods of touring property and survey for real estate transactions.

### BACKGROUND

The invention generally relates to a software based real estate survey system.

Present invention provides real-time data for an owner of a property relative to potential tenant feedback. The data could be used to guide capital projects, enhance the leasing and marketing of the building and show building advantages and shortcomings versus the competition. In addition the data could provide predictive analytics on the likely success of capital improvements. The present invention attempts to solve these problems as well as others.

### SUMMARY OF THE INVENTION

Provided herein are systems and methods of touring property and survey for real estate transactions.

The methods and systems are set forth in part in the description which follows, and in part will be obvious from the description, or can be learned by practice of the methods and systems. The advantages of the methods and systems will be realized and attained by means of the elements and combinations particularly pointed out in the appended claims. It is to be understood that both the foregoing general description and the following detailed description are exemplary and explanatory only and are not restrictive of the methods and systems, as claimed.

### BRIEF DESCRIPTION OF THE DRAWINGS

In the accompanying figures, like elements are identified by like reference numerals among the several preferred embodiments of the present invention.

FIG. 1A is a block diagram of an embodiment of the present real estate transaction system.

FIG. 1B is a continued block diagram of the embodiment of the real estate transaction system shown in FIG. 1A.

FIG. 2 is a block diagram of another embodiment of the present real estate transaction system.

FIG. 3A is the homepage for the system, according to one embodiment.

FIG. 3B is the property detail page, according to one embodiment.

FIG. 3C is the property detail page showing the survey reports in a graphical display.

FIG. 4A is the survey webpage including the list of the surveys completed, according to one embodiment.

FIG. 4B is the Survey detail webpage, according to one embodiment.

FIG. 5 is the Client survey entry page.

### DETAILED DESCRIPTION OF THE INVENTION

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

Embodiments of the invention will now be described with reference to the Figures, wherein like numerals reflect like elements throughout. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

The use of the terms “a” and “an” and “the” and similar referents in the context of describing the invention are to be construed to cover both the singular and the plural, unless otherwise indicated herein or clearly contradicted by context. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any nonclaimed element as essential to the practice of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As used herein the term “method” refers to manners, means, techniques and procedures for accomplishing a given task including, but not limited to, those manners, means, techniques and procedures either known to, or readily developed from known manners, means, techniques and procedures by practitioners of the software and electrical arts. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

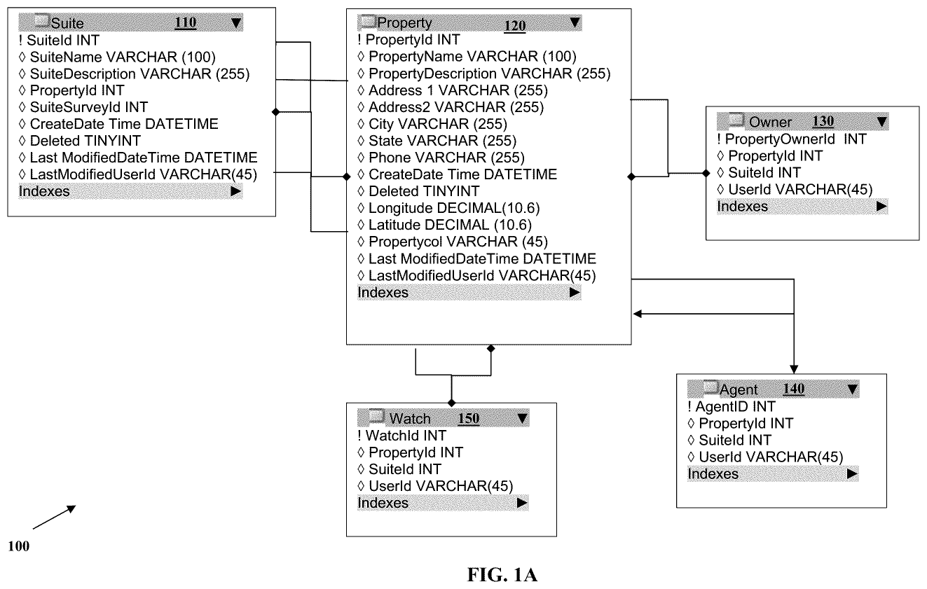

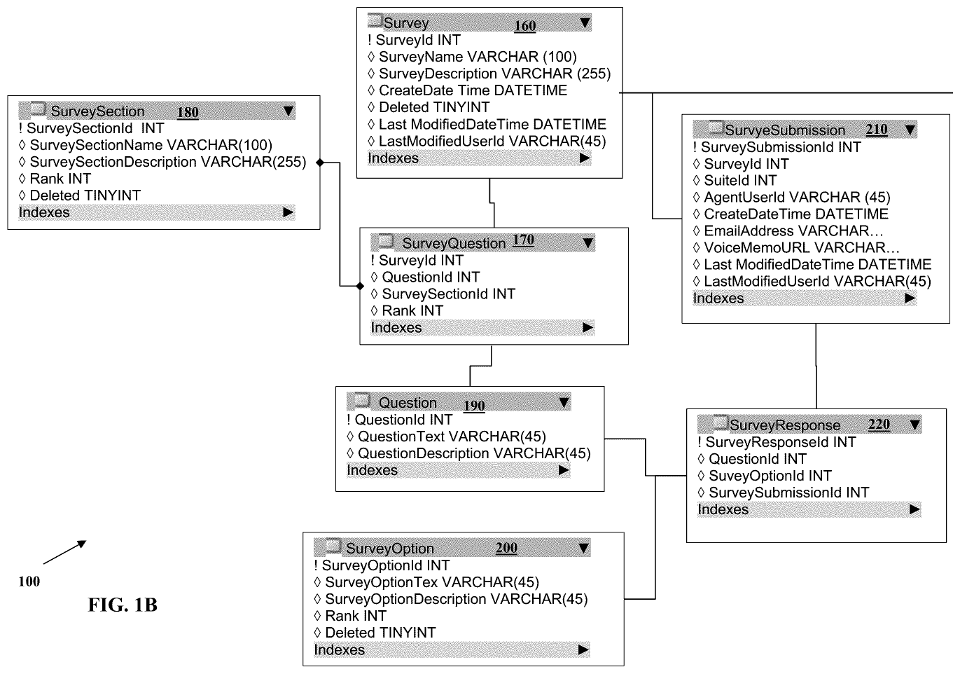

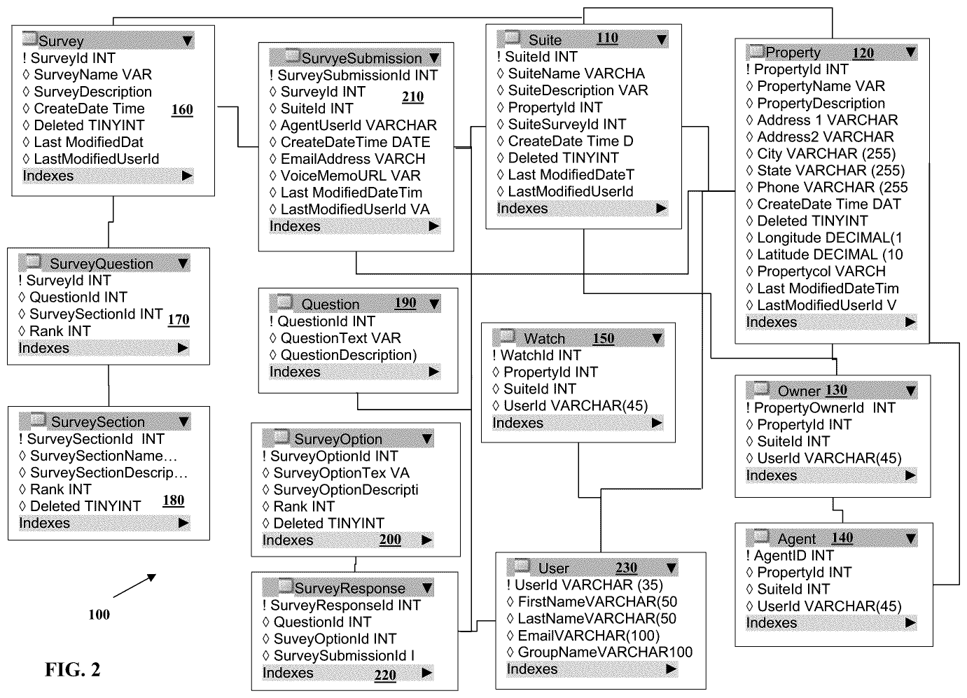

The present invention provides real-time data for an owner of a property relative to potential tenant feedback. The data could be used to guide capital projects, enhance the leasing and marketing of the building, predict the success of capital projects, and show building advantages and shortcomings versus the competition. A software for surveying property for real estate agents and purchasing options comprising a system 100 and a Suite table 110, as shown in FIGS. 1 and 2. A “table” represents a lists of options or directives that may provide input to the survey or may direct the user to another subsequent table to field for selecting other options for the survey. A Suite table 110 represents a specific suite related to a property table 120. A name and a description are stored for each Suite. In one embodiment, there can be multiple suites that relate to a single property or multi-properties. There are options for deletion, a last modification date and time stamps, substitution, and additions in each table. A Property table 120 represents a specific building or address and comprises a name, a description, a first address1, a second address2, a city, a state, a zip code and a phone attribute of field. An Owner table 130 represents a user who owns a property or suite. In one embodiment, there can be zero or more owners aligned to a single property or suite. An Agent table 140 represents a user who is the acting real estate agent for a property or suite. In one embodiment, there can be zero or more agents aligned to a single property or suite. The Agent table 140 may also provide for a broker listing, an attorney listing, or any other agent who may act on behalf of the property. A Watch table 150 represents a user who is watching/following/subscribed to a property or suite. The Watch table may allow a user to receive updates as to how many subscribers or viewers a particular property may obtain on a daily or instantaneous basis.

As shown in FIGS. 1B and 2, a Survey table 160 represents a definition of a survey, according to one embodiment. A name and a description are stored for each Survey, according to one embodiment, and in other embodiment, additional details such as county information, crime rate, walking score, and restaurants/shopping may be provided. A Survey Question table 170 represents the inclusion and order of a specific Question in a specific Survey. A Survey Section 180 represents a grouping of questions in a Survey. In one embodiment, a Name, a description and a rank are attributes of a Survey Section. A Question table 190 represents a specific question that can be included in a Survey, whereby any specific question may be provided for a property. In one embodiment, a Question Text and a Question Description are attributes of a Question. A Survey Option table 200 represents an option or possible answer that a user can select from when taking a survey. In one embodiment, text, description and rank are attributes of a Survey Option. A Survey Submission 210 represents the submission of a user's response to a survey to a server or other computer application. A Survey Submission relates to a single Survey, Suite and Agent. In one embodiment, an Email Address, a Voice Memo and a Tenant Name are attributes of a Survey Submission in addition to zero or more Survey Response records. A Survey Response table 220 represents how a single Question was answered. A Survey Response ties a Question to a selected Survey Option. In one embodiment, there is a Survey Response record for each question/answer pair in a Survey all tying back to a Survey Submission. The User table 230, as shown in FIG. 2, is a table where the system is storing the user's first name, last name, group name, email address and unique identifier, according to one embodiment. Additional information or data may be stored. The User table 230 relates to other tables that store a user Id.

There are database relationships that are defined between the tables and rows, as shown in FIGS. 1-2. For instance, a user has to specify a valid Property Id when creating a new Suite. The following relationships exist for each table, according to one embodiment. The relationships and matching allows the surveys to populate and define the weighted characteristics of each variable.

In one embodiment, a Suite table 110 includes a row that can have many matching rows to one row in the Property table 120, the Suite table 110 includes a row that can have many matching rows to one row in the Survey table 160, the Suite table 110 includes one row matching many rows in the Agent table 140, the Suite table 110 includes one row matching many rows in the Owner table 130, the Suite table includes one row matching many rows in the Watch table 150, the Suite table 110 includes one row matching many rows in the Survey Submission table 210.

In one embodiment, the Property table 120 includes one row matching many rows in the Suite table 110, the Property table 120 includes one row matching many rows in the Agent table 140, the Property table 120 includes one row matching many rows in the Owner table 130, and the Property table 120 includes one row matching many rows in the Watch table 150. The Property table 120 includes a row that can have many matching rows to one row in the Survey table 160.

In one embodiment, the Suite table 110 includes a row that can have many matching rows to one row in the Survey table 160, the Survey table 160 includes one row matching many rows in the Survey Question table 170.

In one embodiment, the Survey Question table 170 includes the Survey table 160 includes one row matching many rows in the Survey Question table 170, the Survey Question table 170 includes a row that can have many matching rows to one row in the Survey Section table 180, and the Survey Question table 170 includes a row that can have many matching rows to one row in the Question table 190.

In one embodiment, the Question table 190 includes the Survey Question table 170 includes a row that can have many matching rows to one row in the Question table 190, the Question table 190 includes one row matching many rows in the Survey Response table 220.

In one embodiment, the Survey Submission table 210 includes the Suite table 110 includes one row matching many rows in the Survey Submission table 210, the Survey Submission table 210 includes one row matching many rows in the Survey table 160, and the Survey Submission table 210 includes one row matching many rows in the Survey Response table 220.

In one embodiment, the Survey Response table 220 includes the Survey Submission table 210 includes one row matching many rows in the Survey Response table 220, the Question table 190 includes one row matching many rows in the Survey Response table 220, and the Survey Response table 220 includes one row matching many rows in the Survey Option table 200.

As shown in FIG. 2, the User table 230 includes one row matching many rows in the Agent table 140, an Owner table 130, a Watch table 150, a Property table 120, a Suite table 110, a SurveySubmission table 210 and a Survey table 160.

FIGS. 1-2 shows an embodiment that is networked (software, app, or internet) real estate property interface portal (website) as contemplated by the present disclosure. The interface communicates both wirelessly and wired with real estate agents/brokers (and their offices), potential real estate buyers, and sellers via one or more networks. Such communication may be provided via a combination of telecommunication carriers and Internet service providers.

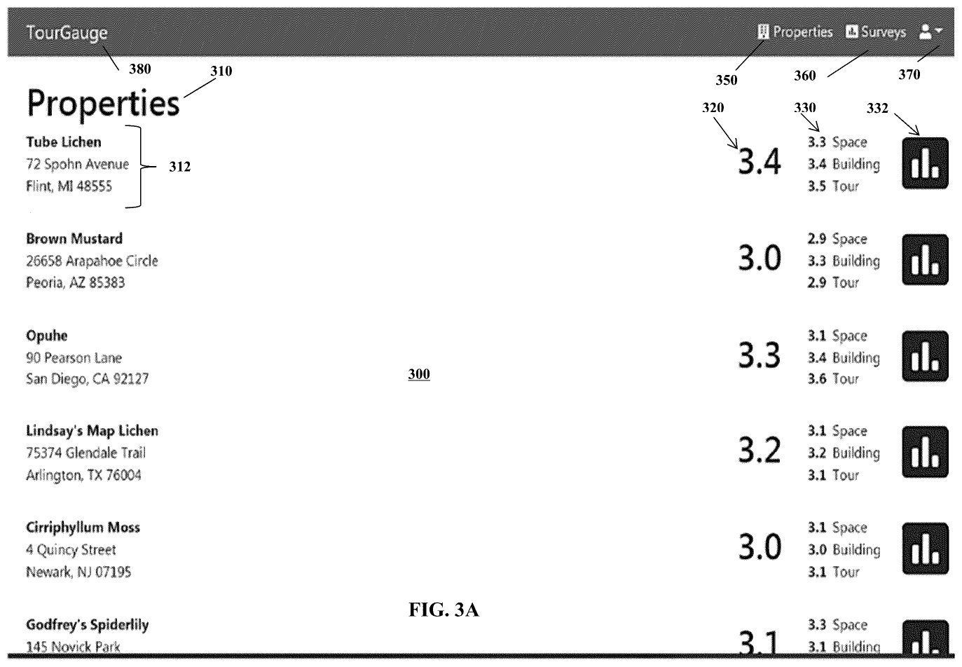

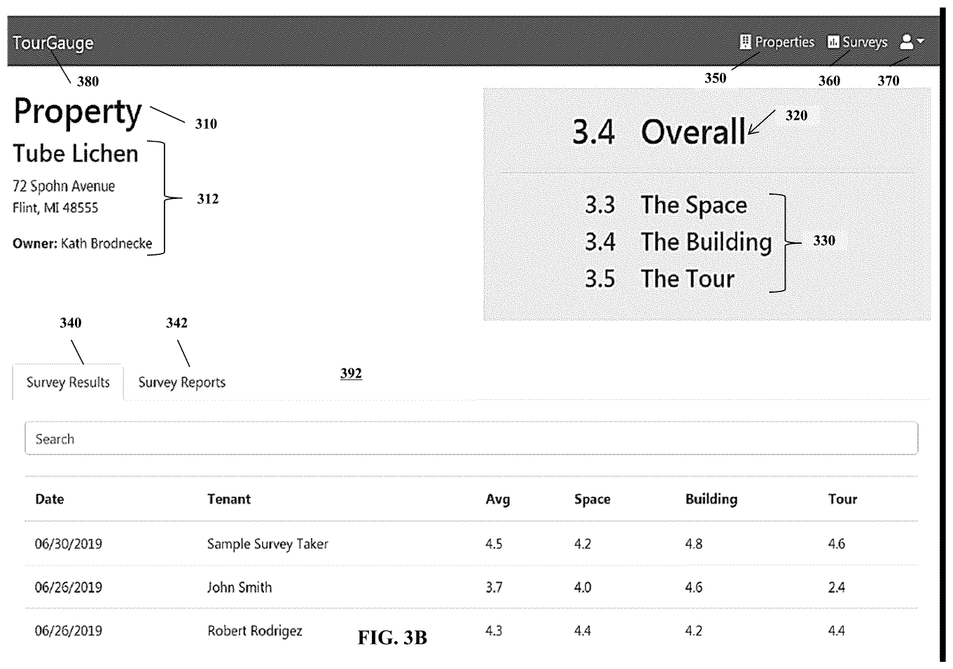

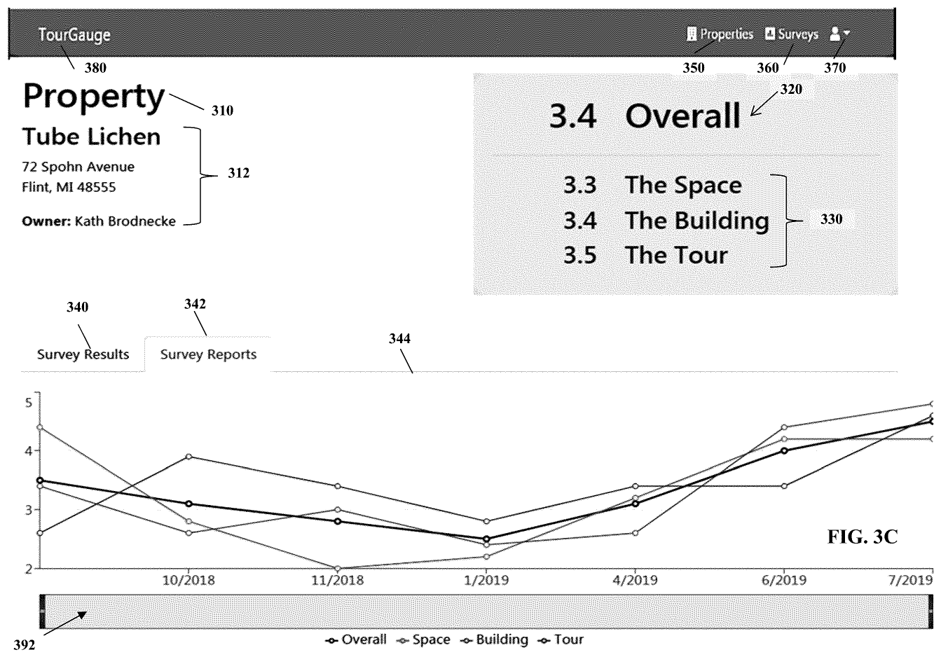

FIG. 3A is the homepage 300 for the system, where a list of properties 310 are shown where surveys have been completed. The list of properties 310 includes the general property information 312, such as the owner, address, city, state, and the like. An overall score 320 is shown for the property 310 including a breakdown of the survey score into individual categories 330. The individual categories 330 include, but are not limited to, the space, building, and tour. A graphic chart icon 332 is displayed, which then links to Client survey entry page 500. The homepage 300 for the properties includes direct links to the homepage 380, links to the survey webpage 360, a user account/log off link 370, and a Properties link 350. Clicking the individual properties 310, overall score 320, or the graphic chart icon 340 will lead the user to the survey webpage 400. Clicking on the generating property listing 312 links to a property detail page 390, as shown FIG. 3B.

In one embodiment, the property detail page 392 includes the general property information 312, such as the property name, owner, address, city, state, and the like. The overall score 320 is shown for the property 310 including a breakdown of the survey score into individual categories 330. The survey results are shown in the graphic chart icon 340, which includes the date of the survey was taken, the name of the tenant, the average score, and sub-scores for the space, building, and tour. The Survey reports 342 links to a graphical display 344 of the surveys taken, as shown in FIG. 3C, with the score on the y-axis, and the date on the x-axis. The overall score 320 is shown for the property 310 including a breakdown of the survey score into individual categories 330 is shown in the graphical display 344.

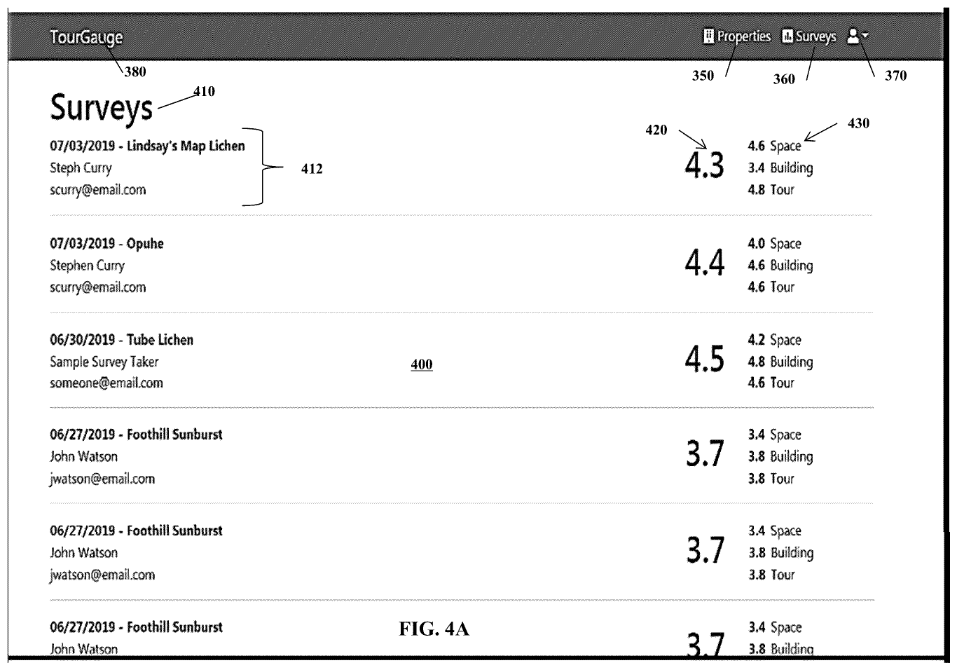

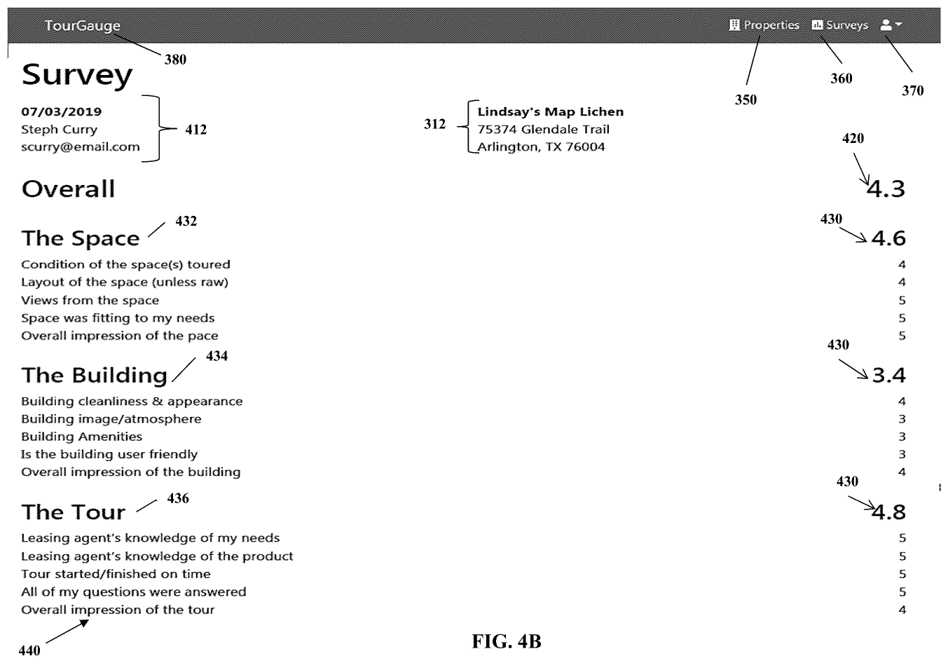

In one embodiment, the survey webpage 400 is shown in FIG. 4A, where a list of the surveys 410 is provided. The list of surveys 410 includes the general survey information 412, including the surveyor's name, date of survey completion, email, and the like. The overall survey score 420 is shown for the survey 410 including a breakdown of the survey score into individual categories score 430. The individual categories score 430 include, but are not limited to, the space, building, and tour. A link on the individual categories score 430 or the overall survey score 420 links to a Survey detail 440, as shown in FIG. 4B.

In one embodiment, the Survey detail 440 includes the general survey information 412 and the generating property information 312, the overall survey score 420 and the individual categories scores 430. The individual categories score 430 include the space 432, the building 434, the tour 436 with a corresponding score. The space 432 includes condition of the space(s) toured, layout of the space (unless raw), views from the space, space was fitting to my needs, and overall impression of the space. The building 434 includes Building cleanliness & appearance, Building image/atmosphere, Building Amenities, Is the building user friendly, Overall impression of the building. The tour 436 includes Leasing agent's knowledge of my needs, Leasing agent's knowledge of the product, Tour started/finished on time, All of my questions were answered, Overall impression of the tour.

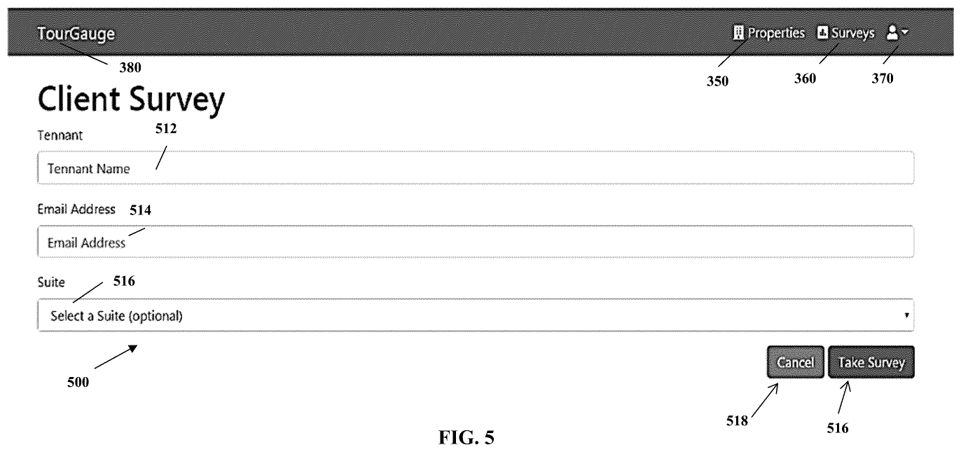

In one embodiment, the Client survey entry page 500 is shown in FIG. 5. The Tenant name field 510 is displayed to enter the Tenant name. The email address field 512 is displayed to enter the email address, and the Suite field 514 is displayed to enter the optional suite number. The Take Survey button 516 is displayed to begin taking the survey and the Cancel button 518 allows a cancel of the operation to clear the fields.

Communication with the portal is generally via the network interface which provides both secure (e.g., virtual private network) communications and less secure network communications as provided by most websites. Interface communicates with accessibility subsystem for determining the access level to be provided to users requesting access. The following types of users are distinguished by this subsystem: (i) agents/brokers registered to use the services of the portal, (ii) potential real estate buyers or seller registered to use the services of the portal, and (iii) non-registered users. The accessibility subsystem also registers users for allowing greater access to the portal's services. In addition to users being able to contact the portal, this portal can also transmit surveys (e.g., via email, synthesized voice messages, instant messaging, and/or text messaging) to agents, buyers, sellers and other parties pertinent to a real estate transaction. To perform such communications, the portal includes a notification system for receiving survey information and an identification of one or more recipients, wherein the system determines the transmission techniques to be used and the order they should be employed. Accordingly, an agent may have input information to the portal requesting to be notified of requested real estate showings of his/her listings via synthesized surveys requiring confirmation of receipt and/or review, followed by a text message text message if no such confirmation is received from the agent within, e.g., 15 minutes. However, for other users (e.g., a potential real estate buyer), such notifications may be only via wireless transmissions such as email or instant messaging without confirmation of review by the buyer being required. The notification system provides its output to a user device presentation determiner which tailors the survey or notification for output to be appropriate for the intended user device that is to receive the survey or notification. Accordingly, if the intended device is a portal computer with sufficient graphics display capabilities, then maps and various photo and/or video data streams may be transmitted to the device. However, if the intended device is a mobile phone with a small display screen, or a pager, then only text messages (perhaps with reduced graphics) may be transmitted (possibly together with information for logging onto the portal to receive additional information regarding the survey). The presentation determiner, in at least one embodiment, communicates with a routing or navigation subsystem for obtaining directions to a particular location. Accordingly, the presentation determiner may provide the routing subsystem with data requesting that only textual navigational information be supplied; alternatively, such data may request graphical mapping information be supplied as well. The navigation subsystem may, in turn, contact any one of a number of navigation services well known in the art.

Client and Survey Profiles

The agent/client can also use the portal to access information on newly listed survey for determining if he/she should visit the property.

The agent may provide the portal with an survey property profile, wherein the profile includes filters that prevent certain agent notifications for new property listings under certain circumstances, e.g., if the asking price is outside of a predetermined price range, if the property location is outside of one or more agent selected geographical areas, etc. However, such filters associated with the agent's profile may be overridden if a client of the agent has a current property profile that identifies a property that would otherwise be filtered by the agent's profile. Accordingly, an agent may be notified by a plurality of survey profiles, wherein most of the survey profiles in the collection are profiles exported to the agent from particular clients. Thus, an agent may be notified of any property listing (new or old) if the survey satisfies a client profile exported by the client (and accepted by the agent). Moreover, the agent may have a select group of properties that are not currently publicly available, and the agent can provide information on these properties so that such information is made only available to the agent's clients (or the agent's real estate office clients) for a predetermined time prior to making such properties publicly available to other agents and their clients. Accordingly, new property listings in the database of currently available properties are partitioned into groups.

When using the services of the portal, a registered user (agent or client) may create and/or select one or more of his/her property profiles and store such survey profiles at the portal for determining any properties that satisfy at least one such survey profile. In one embodiment, the user may store a large plurality of such survey profiles (e.g., 30 or more). For example, a potential buyer may have a different property profile for each of commercial real estate properties, apartment complexes, personal residence properties, vacation home(s), undeveloped land, etc. Moreover, a user may have one or more temporary or experimental profiles stored at the portal as well as one or more that are exported to another user (e.g., a client's agent).

Agents may create proprietary property surveys for their clients that assist these clients in identifying properties of interest. Such proprietary surveys may be created or generated substantially via the agent's personal experience (e.g., manually by the agent) and/or with the assistance of various client personality and/or demographic profiling tools. An agent (or an agent's office) may keep client and surveys profiles on clients that buy a property, and clients that do not buy a property. If a client profile (having some preferred property characteristics) for a current client sufficiently matches a corresponding composite client profile of a particular group of past clients that have purchased properties, then if the survey characteristics of the purchased properties by members of the group can be correlated with the property purchases, then such survey characteristics may be predictive of other clients purchasing properties having the same or similar survey characteristics. Note that since any correlation between a survey profile for a property purchasing client group, and the satisfied survey preferences is probabilistic, at least some survey profiles generated may be based on a fuzzy logic model or a statistical model. For example, principal components statistical analysis may be performed for identifying survey profile characteristics (if any) that are predictive of a purchase by clients having a similar client profiles. Accordingly, if such client profile characteristics can be determined to correlate with particular survey characteristics of properties that were actually purchased by past clients, then such survey characteristics may be used (e.g., in combination with desired survey characteristics in, e.g., the client profile) for generating a more nearly complete property profile that may be predictive of a property the client may purchase. Thus, by determining which of a plurality of group profiles (each such profile for a group of past clients having similar client profiles, and that purchased properties) is most similar to a current client's profile, at least some property characteristics may be likely predictive of the client purchasing a property having the property characteristics. Accordingly, the agent has the capability to provide property suggestions to a client based on purchasing experience of past clients without requiring the client to schedule a time to discuss the client's property objectives and preferences. Note that it is possible that an initial client profile (including a collection of property preferences supplied by a client) can indicate that the client is unlikely to purchase a property consistent with the client's property preferences.

Moreover, if corresponding survey profile data is also retained on clients that did not purchase a property, together with corresponding property profile data used by such non-purchasing clients, and the number of matches for such property profiles, then it may possible to statistically predict after a certain number of survey profiles are used by the client whether the client is more or less likely to purchase a property than another client. Accordingly, an agent may wish to allocate his/her time to clients that are identified as being more likely to purchase a property.

Since certain survey profiles may be designated as the active survey profiles for notifying the client and his/her agent of newly available properties for sale, changes in such active survey profiles over time may be also used in predicting a likelihood of the client purchasing a property prior to the agent's contract with the client expiring. For example, substantially no changes in a client's property profile to reflect changing market conditions (e.g., changing to a “sellers market”) may be indicative that the client is unlikely to purchase a property. Alternatively, when a client's active property profile progressively becomes more focused, the agent may likely assume that the client has determined what property characteristics are desired, and accordingly the agent may determine that additional time should be spent assisting the client in purchasing a property. However, if a client's active survey profile changes focus repeatedly to substantially different populations of properties, then the agent may quite likely assume the client unclear in his/her property purchasing objectives, and accordingly may contact the client to offer advice. Note, that since the present real estate transaction system allows clients to investigate properties for sale substantially autonomously from their real estate agent, the agent can afford to service a large number of clients since it is likely that only a few of the agent's clients at any given time at the stage of requiring a significant amount of the agent's time, e.g., for submitting an offer on a property and/or negotiating a contract and/or closing on a property. Accordingly, the present real estate transaction system may provide agents with access to tools that assist an agent with determining distinctions between various versions of the active property profiles for a given client. Note that since clients (and their agents) can experiment by generating non-active survey profiles for determining what types of properties are available, it is believed that only a few (possibly only one) active property profile is generally needed per client. Thus, since the agent may only be provided with a client's active survey profile, the agent is spared the task of reviewing most of the client's property investigations. Moreover, the goal of exporting an active property profile to a client's agent is believed to be a goal that will motivate clients to be more self-directed in selecting and identifying their property preferences.

The software may include location identifying devices are structured to define the precise location of the smartphone. In one preferred embodiment, devices using Apple's iBeacon technology are used as the location identifying devices. The iBeacon-enabled devices communicate using Bluetooth Low Energy. In contrast to Global Positioning Satellite (GPS) technology, which can only define a device's location within a fairly wide range and which may not function within buildings, tunnels, cloud cover and other locations that do not have a clear line of sight to the sky where the satellites are located, Bluetooth Low Energy can define locations within very short distances without the same line of site issues associated with GPS. Although the following description of one preferred embodiment describes usage of iBeacon-enabled devices as the location identifying devices, it should be appreciated that other location identifying devices now known or later developed may be utilized with the system of the present invention within the spirit and scope of the invention.

The user device may be comprised of any type of computer for practicing the various aspects of the present invention. The user device will preferably be adapted to communicate with the central communication unit via the communications network. The user device may connect with the central communication unit via a website (i.e. through a web browser) or via a software application (i.e. by downloading the application from a mobile application store, such as GOOGLE PLAY STORE or APPLE ITUNES).

By way of example, the user device can be a personal computer (e.g. APPLE® based computer, an IBM based computer, or compatible thereof) or tablet computer (e.g. IPAD®). The user device may also be comprised of various other electronic devices capable of sending and receiving electronic data including but not limited to smartphones, mobile phones, telephones, personal digital assistants (PDAs), mobile electronic devices, handheld wireless devices, two-way radios, smart phones, communicators, video viewing units, television units, television receivers, cable television receivers, pagers, communication devices, and digital satellite receiver units.

The present invention may be implemented and viewed upon various types and brands of web/e-mail browsers run on a user device such as but not limited to MICROSOFT INTERNET EXPLORER, NETSCAPE NAVIGATOR, MOZILLA FIREFOX, SAFARI, OPERA, AMAYA, ARENA, LYNX, HOTJAVA, MOZILLA, ICAB, MICROSOFT OUTLOOK, and MICROSOFT OUTLOOK EXPRESS. Browsers for handheld wireless devices, often times referred to as “microbrowsers”, are also capable of implementing the present invention. A browser is typically capable of displaying/playing various types of content including but not limited text, graphic, audio and multimedia.

The present invention may also be implemented and viewed through a software application similarly run on a user device 30. The software application may be implemented through various operating systems such as but not limited to MICROSOFT WINDOWS, LINUX, APPLE IOS, ANDROID, and the like. The software application may be distributed in physical form to be installed upon the user device or may be distributed via the communications network.

In general, a mobile telecommunications device may include any mobile telecommunications device such as, but not limited to, a mobile (e.g., cellular) phone or equivalent, including an iPhone™, Droid™, or the like. A mobile telecommunications device typically may include a processor or other computing module/device which may include software, hardware, or the like, including machine readable code configured to operate the device to receive and/or send information from the apparatus described herein. Such code may be provided with, or separately from, the apparatus described. A mobile telecommunications device may be referred to (and includes) a cell or cellular phone or telephone, a mobile phone or telephone, a smartphone, smart eye glasses (Google Glasses™) or virtual reality glasses; an handheld computer, tablet, a wearable computer, a wearable sensor, an electronic book reader, electronically-functional jewelry, or the like. Code may be referred to a software, or application software (“app” or “application”) and may be downloaded from a remote location onto the mobile telecommunications device.

Software includes applications and algorithms. Software may be implemented in a smart phone, tablet, or personal computer, in the cloud, on a wearable device, or other computing or processing device. Software may include logs, journals, tables, games, recordings, communications, SMS messages, Web sites, charts, interactive tools, social networks, VOIP (Voice Over Internet Protocol), e-mails, and videos.

A social networking service (also social networking site or SNS) is a platform to build social networks or social relations among people who share similar interests, activities, backgrounds or real-life connections. A social network service consists of a representation of each user (often a profile), his or her social links, and a variety of additional services such as career services. Social network sites are web-based services that allow individuals to create a public profile, create a list of users with whom to share connections, and view and cross the connections within the system. Most social network services are web-based and provide means for users to interact over the Internet, such as e-mail and instant messaging. Social network sites are varied and they incorporate new information and communication tools such as mobile connectivity, photo/video/sharing and blogging. Online community services are sometimes considered a social network service, though in a broader sense, social network service usually means an individual-centered service whereas online community services are group-centered. Social networking sites allow users to share ideas, pictures, posts, activities, events, and interests with people in their network. The main types of social networking services are those that contain category places (such as former school year or classmates), means to connect with friends (usually with self-description pages), and a recommendation system linked to trust. Popular methods now combine many of these, with American-based services such as Facebook, Google+, LinkedIn, Instagram, Reddit, Pinterest, Vine, Tumblr, and Twitter widely used worldwide; Nexopia in Canada; Badoo, Bebo, Vkontakte (Russia), Delphi, Draugiem.lv (Latvia), iWiW (Hungary), Nasza-Klasa (Poland), Soup (Austria), Glocals in Switzerland, Skyrock, The Sphere, StudiVZ (Germany), Tagged, Tuenti (mostly in Spain), Myspace, Xanga and XING in parts of Europe; Hi5 in South America and Central America; Mxit in Africa; Cyworld, Mixi, Renren, Friendster, Sina Weibo and Wretch in Asia and the Pacific Islands.

System

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a telecommunications network, such as the Internet.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

All publications and patent applications mentioned in this specification are herein incorporated by reference to the same extent as if each individual publication or patent application was specifically and individually indicated to be incorporated by reference.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

1.-30. (canceled)

31. A Method of Touring Real Estate and generating Surveys comprising:
a. Generating a list of properties where surveys are to be completed;
b. Providing an overall score for the property including a breakdown of the survey score into a plurality of individual categories;
c. Providing a graphic chart icon, which is linked to a Client survey entry page;
d. Providing a homepage for the properties including a direct link to the homepage;
e. Linking a survey webpage, a user account/log off link, and a Properties link 350;
f. providing an individual property, overall score, or the graphic chart icon linked to the survey webpage;
g. providing the property listing to a property detail page; wherein the list of properties includes at least one property information selected from the group consisting of: an owner, an address, a city, and a state; wherein the plurality of individual categories include a space, a building, and a tour; wherein the property detail page includes at least one property information selected from the group consisting of: a property name, an owner, an address, a city, and a state;
h. providing the survey results, wherein the survey results include a date of the survey was taken, a name of the tenant, an average score, and a plurality of sub-scores for the space, building, and tour;
i. linking the survey reports to a graphical display of the surveys taken with the score on a y-axis, and the date on an x-axis; and showing the overall score including a breakdown of a survey score into individual categories in the graphical display;
j. providing a list of the surveys on the survey webpage; the list of surveys includes a general survey information selected from the group consisting of: a surveyor's name, a date of survey completion, and an email; providing an overall survey score on the survey webpage including a breakdown of the survey score into individual categories score; and linking the individual categories or the overall survey score to a Survey detail;
k. providing the Survey detail including the general survey information and the property information, the overall score and the individual categories scores; and
l. where the individual categories include a space, a building, the a tour with a corresponding score; the space includes condition of the space(s) toured, layout of the space, views from the space, space was fitting to my needs, and overall impression of thee space; the building includes Building cleanliness & appearance, Building image/atmosphere, Building Amenities, Is the building user friendly, Overall impression of the building; and the tour includes Leasing agent's knowledge of my needs, Leasing agent's knowledge of the product, Tour started/finished on time, All of my questions were answered, Overall impression of the tour;
m. providing the Client survey entry page including a Tenant name field to enter the Tenant name; providing an email address field to enter the email address, providing a Suite filed to enter an optional suite number; providing a Take Survey button to begin taking the survey; and providing a Cancel button allowing a cancel of an operation to clear the fields.

32. The method of claim 31, further comprising operating the method on a non-transitory computer readable storage medium.

33. A non-transitory computer-readable storage medium comprising instructions stored thereon, which, when executed by at least one processor causes the at least one processor to perform operations of generating a Survey including a list of properties, wherein a list of properties includes at least one property information selected from the group consisting of: an owner, an address, a city, and a state.

34. The non-transitory computer-readable storage medium of claim 33, wherein a plurality of individual categories include a space, a building, and a tour.

35. The non-transitory computer-readable storage medium of claim 34, wherein a property detail page includes at least one property information selected from the group consisting of: a property name, an owner, an address, a city, and a state.

36. The non-transitory computer-readable storage medium of claim 35, further comprising providing the survey results, wherein the survey results include a date of the survey was taken, a name of the tenant, an average score, and a plurality of sub-scores for the space, building, and tour.

37. The non-transitory computer-readable storage medium of claim 36, linking the survey reports to a graphical display of the surveys taken with the score on a y-axis, and the date on an x-axis; and showing an overall score including a breakdown of the survey score into individual categories in the graphical display.

38. The non-transitory computer-readable storage medium of claim 37, further comprising providing a list of the surveys on a survey webpage; the list of surveys includes a general survey information selected from the group consisting of: a surveyor's name, a date of survey completion, and an email; providing an overall survey score on the survey webpage including a breakdown of the survey score into individual categories score; and linking the individual categories or the overall survey score to a Survey detail.

39. The non-transitory computer-readable storage medium of claim 38, further comprising providing the Survey detail including the general survey information and the property information, the overall score and the individual categories scores.

40. A non-transitory computer-readable storage medium containing instructions stored thereon, which, when executed by at least one processor causes the at least one processor to perform operations of generating Survey comprising: a system including a Suite table, an Owner table, an Agent table, a Survey table, a Survey question table, a Survey Section table, a Question table, a Survey Option table, a Survey Submission table, a Survey Response table, and a User table, where a plurality of database relationships are defined between the tables;
a. wherein the Suite is related to a property; storing a name and a description for the Suite; the Property represents a specific building or address and comprises a name, a description, a first address, a second address, a city, a state, a zip code and a phone attribute of field; an Owner represents a user who owns a property or suite; an Agent represents a user who is the acting real estate agent for a property or suite; and a Watch represents a user who is interested in a property or suite; a Survey represents a definition of a survey and storing a name and a description for each Survey; the Survey Question represents the inclusion and order of a specific Question in a specific Survey; the Survey Section represents groupings of questions in the Survey; the Question represents a specific question that is included in the Survey; the Survey Option an option or possible answer that a user can select from when taking a survey; the Survey Submission represents the submission of a user's response to a single Survey, Suite and Agent; the Survey Response represents how a single Question was answered and the Survey Response ties a Question to a selected Survey Option; and the User table is a table where the system is storing the users first name, last name, group name, email address and unique identifier, and the User table relates to other tables that store a user Id.

41. The non-transitory computer-readable storage medium of claim 40, wherein the user has to specify a valid Property Id when creating a new Suite; and the following relationships exist for each table, wherein:
a. the Suite table includes a plurality of matching rows, a Property table includes a plurality of matching rows, the Survey table includes a plurality of matching rows, the Agent table includes a plurality of matching rows, the Owner table includes a plurality of matching rows, the Watch table includes a plurality of matching rows, Survey Submission includes a plurality of matching rows; the Survey Question table includes a plurality of matching rows, the Survey Section table includes a plurality of matching rows, the Question table includes a plurality of matching rows, the Survey Response table includes a plurality of matching rows, Survey Submission table includes a plurality of matching rows;
b. the at least one of the plurality of matching rows of the Suite table matches to one row of the plurality of matching rows in the Property table;
c. the at least one of the plurality of matching rows of the Suite table matches to one row of the plurality of matching rows in the Survey table;
d. the at least one of the plurality of matching rows of the Suite table matches to one row of the plurality of matching rows in the Agent table;
e. the at least one of the plurality of matching rows of the Suite table matches to one row of the plurality of matching rows in the Owner table;
f. the at least one of the plurality of matching rows of the Suite table matches to one row of the plurality of matching rows in the Watch table;
g. the at least one of the plurality of matching rows of the Suite table matches to one row of the plurality of matching rows in the Survey Submission table;
h. the at least one of the plurality of matching rows of the Property table matches to one row of the plurality of matching rows in the Suite table;
i. the at least one of the plurality of matching rows of the Property table matches to one row of the plurality of matching rows in the Agent table;
j. the at least one of the plurality of matching rows of the Property table matches to one row of the plurality of matching rows in the Owner table;
k. the at least one of the plurality of matching rows of the Property table matches to one row of the plurality of matching rows in the Watch table;
l. the at least one of the plurality of matching rows of the Property table matches to one row of the plurality of matching rows in the Survey table;
m. the at least one of the plurality of matching rows of the Suite table matches to one row of the plurality of matching rows in the Survey table;
n. the at least one of the plurality of matching rows of the Survey table matches to one row of the plurality of matching rows in the Survey Question table;
o. the at least one of the plurality of matching rows of the Survey table matches to one row of the plurality of matching rows in the Survey Question table;
p. the at least one of the plurality of matching rows of the Survey Question table matches to one row of the plurality of matching rows in the Survey Section table;
q. the at least one of the plurality of matching rows of the Survey Question table matches to one row of the plurality of matching rows in the Question table;
r. the at least one of the plurality of matching rows of the Survey Question table matches to one row of the plurality of matching rows in the Question table;
s. the at least one of the plurality of matching rows of the Question table matches to one row of the plurality of matching rows in the Survey Response table;
t. the at least one of the plurality of matching rows of the Suite table matches to one row of the plurality of matching rows in the Survey Submission table;
u. the at least one of the plurality of matching rows of the Survey Submission table matches to one row of the plurality of matching rows in the Survey table;
v. the at least one of the plurality of matching rows of the Survey Submission table matches to one row of the plurality of matching rows in the Survey Response table;
w. the at least one of the plurality of matching rows of the Question table matches to one row of the plurality of matching rows in the Survey Response table; and
x. the at least one of the plurality of matching rows of the Survey Response table matches to one row of the plurality of matching rows in the Survey Option table;

42. The non-transitory computer-readable storage medium of claim 41, wherein the property includes a plurality of suites.

43. The non-transitory computer-readable storage medium of claim 41, further comprising options for deletion, a last modification date and time stamps in each table.

44. The non-transitory computer-readable storage medium of claim 41, there can be zero or more owners aligned to a single property or suite.

45. The non-transitory computer-readable storage medium of claim 41, wherein further comprising zero or more agents aligned to a single property or suite.

46. The non-transitory computer-readable storage medium of claim 41, wherein a Name, a description and a rank are attributes of a Survey Section.

47. The non-transitory computer-readable storage medium of claim 41, wherein the Question comprises a Question Text and a Question Description.

48. The non-transitory computer-readable storage medium of claim 41, wherein the Survey Option comprises a text, a description and a rank.

49. The non-transitory computer-readable storage medium of claim 41, wherein the Survey Submission comprises an Email Address, a VoiceMemo and a Tenant Name.

50. The non-transitory computer-readable storage medium of claim 41, further comprising a Survey Response record for each question/answer pair in a Survey all tying back to a Survey Submission.
